(19) United States
(12) Patent Application Publication
(10) Pub. No.: US 2018/0151972 A1
(43) Pub. Date: May 31, 2018

(54) FEMALE ELECTRICAL TERMINAL

(71) Applicant: Lear Corporation, Southfield, MI (US)

(72) Inventors: Michael Balser, Remscheid (DE); Rainer Busies, Wuppertal (DE); Robert Klawinski, Remscheid (DE); Serge Wittenbeck, Remscheid (DE)

(73) Assignee: Lear Corporation, Southfield, MI (US)

(21) Appl. No.: 15/728,154

(22) Filed: Oct. 9, 2017

(30) Foreign Application Priority Data
Nov. 30, 2016 (DE) 102016123163.0

(51) Int. Cl. H01R 13/10

(52) U.S. Cl. CPC H01R 13/10

(57) ABSTRACT

A female electrical terminal includes an attachment portion. The female electrical terminal also includes a contact portion connected to the attachment portion. The contact portion includes contact arms located on opposed sides of a terminal axis. The contact arms are adapted to engage a corresponding male terminal inserted along the terminal axis. The female electrical terminal also includes a notch located in one of the contact arms.

### BACKGROUND OF THE INVENTION

This invention relates in general to female electrical terminals. More specifically, this invention relates to an improved structure for a female electrical terminal that includes features to allow for tuning of an insertion force.

A male blade terminal is adapted to mate with a corresponding female electrical terminal. The female electrical terminal typically includes one or more pairs of contact arms that engage the sides of the male blade terminal when the terminals are mated. The contact arms are pushed apart by the male blade terminal and, thus, apply pressure against the male blade terminal in order to maintain electrical contact between the male blade terminal and the female electrical terminal. The force applied to the male blade terminal by the contact arms resists the male blade terminal being mated with the female electrical connector, and further resists the male blade terminal being separated from the female electrical terminal. The force applied to the male blade terminal varies depending on various characteristics of the male blade terminal and the female electrical terminal, including the size of the male blade terminal, the material both terminals are made of, the surface characteristics of the terminals, the size of the contact arms on the female electrical terminal, the thickness of the contact arms, and the spacing between the contact arms. The dimensions of the female electrical terminal are typically selected based on various characteristics including the material the terminal is made of, the amount of electrical current the terminal is expected to conduct, and the size available. In some situations, it is desirable to reduce the force that the contact arms apply to the male blade terminal. It would be advantageous to have an improved way to adjust the force a female electrical terminal applies to a corresponding male blade terminal.

### SUMMARY OF THE INVENTION

This invention relates to a female electrical terminal. The female electrical terminal includes an attachment portion. The female electrical terminal also includes a contact portion connected to the attachment portion. The contact portion includes contact arms located on opposed sides of a terminal axis. The contact arms are adapted to engage a corresponding male blade terminal inserted along the terminal axis. The female electrical terminal also includes a notch located in one of the contact arms.

This invention also relates to a female electrical terminal that includes an attachment portion and a contact portion connected to the attachment portion. The contact portion includes a box structure located around the terminal axis. Contact arms extend from the box structure on opposed sides of the terminal axis in an insertion direction that is substantially parallel to the terminal axis. Guides also extend from the box structure on opposed sides of the terminal axis farther in the insertion direction than the contact arms.

This invention also relates to a female electrical terminal that includes an attachment portion and a contact portion connected to the attachment portion. The contact portion includes a box structure that is located around and extends along a terminal axis. The contact portion also includes contact arms extending from the box structure on opposed sides of the terminal axis. The contact arms are adapted to engage a corresponding male blade terminal inserted along the terminal axis. The box structure also includes at least one projection and at least one corresponding recess. The projection and the recess have mutually opposing surfaces. The mutually opposing surfaces cooperate to prevent the box structure from coming apart about the terminal axis due to insertion of a male blade terminal into the female electrical terminal.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a prior art female electrical terminal.

FIG. 2 is a perspective view of a female electrical terminal in accordance with the invention.

FIG. 3 is a top plan view of a stamped metal blank that can be folded to create the female electrical terminal shown in FIG. 2.

FIG. 4 is a top plan view of the female electrical terminal shown in FIG. 2.

FIG. 5 is a side elevational view of the female electrical terminal shown in FIG. 2.

FIG. 6 is cross-sectional view of a portion of the female electrical terminal taken along line 6-6 of FIG. 5.

### DETAILED DESCRIPTION OF THE PREFERRED EMBODIMENT

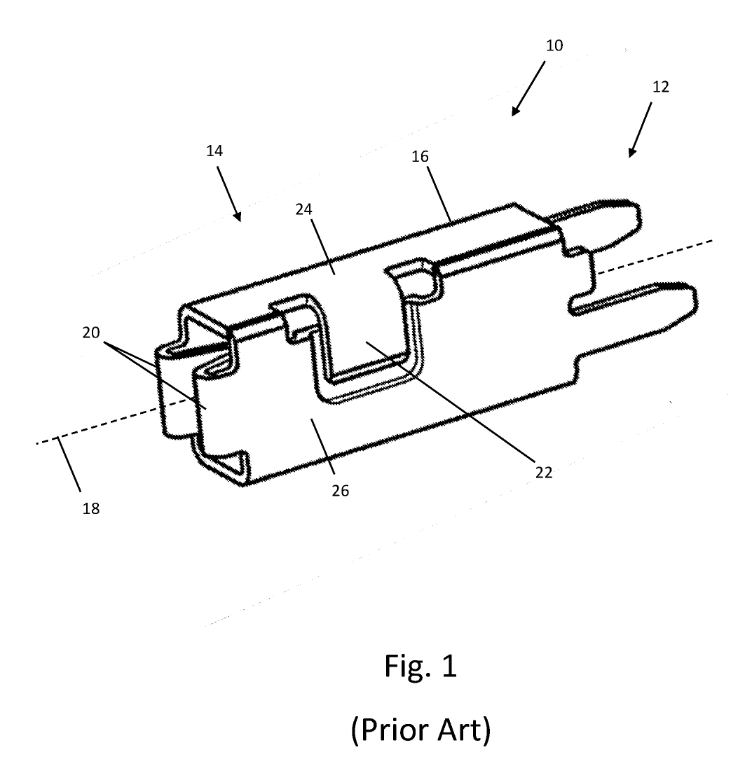

Referring now to the drawings, there is illustrated in FIG. 1 a prior art female electrical terminal, indicated generally at 10. The prior art female electrical terminal 10 includes an attachment portion, indicated generally at 12, that is adapted to be connected to a circuit board (not shown) by soldering. The prior art female electrical terminal 10 also includes a contact portion, indicated generally at 14, that is adapted to engage a corresponding male terminal (not shown) such as, for example a generally flat male blade terminal. The contact portion 14 includes a structure that is laterally closed (or at least substantially laterally closed), such as a box structure 16 that is located around a terminal axis 18. Two contact arms 20 extend from the box structure 18 on opposed sides of the terminal axis 18, and each contact arm 20 extends toward the terminal axis 18. The contact arms 20 engage the corresponding male blade terminal when it is mated with the prior art female electrical terminal 10 along the terminal axis 18. The box structure 16 includes a tab 22 that extends from a first side 24 of the box structure 16 and is folded against a second side 26 of the box structure 16.

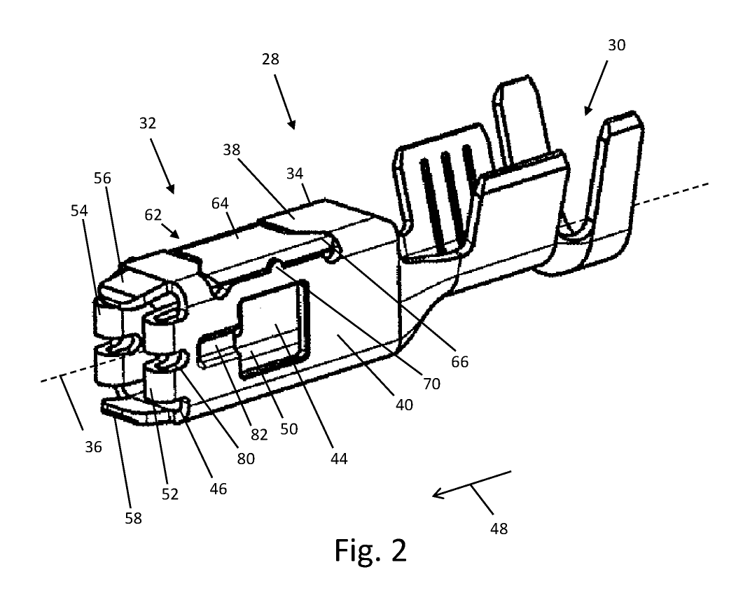

Referring to FIG. 2, there is illustrated a perspective view of a female electrical terminal in accordance with the invention, indicated generally at 28. The illustrated female electrical terminal 28 includes an attachment portion, indicated generally at 30, that is adapted to be connected to a wire (not shown) by crimping, as is well-known in the art. However, the female electrical terminal 28 may be adapted to be connected to a wire or other conductive member in any other desired way. The female electrical terminal 28 also includes a contact portion, indicated generally at 32, which is adapted to engage a corresponding male terminal such as, for example a generally flat male blade terminal (not shown). The contact portion 32 includes a box structure 34 that is located around and extends along a terminal axis 36. The box structure 34 includes four walls 38, 40, 42, and 44. The box structure 34 may include a different number of walls if desired. Each of the walls 38, 40, 42, and 44 is substantially parallel to the terminal axis 36, although such in not required. The box structure 34 defines an insertion opening 46 that is located around the terminal axis 36. When the female electrical terminal 28 is mated with the corresponding male blade terminal, it is moved in an insertion direction 48 that is substantially parallel to the terminal axis 36 so that the male blade terminal is inserted along the terminal axis 36 through the insertion opening 46 into an interior space 50 defined by the box structure 34. Contact arms 52 and 54 extend from the box structure 34 and are adapted to engage the corresponding male blade terminal when it is mated with the female electrical terminal 28. The contact arms 52 and 54 will be described below. Guides 56 and 58 also extend from the box structure 34 and will also be described below.

Referring now to FIG. 3, a plan view of a stamped blank, indicated generally at 60, is shown. The illustrated stamped blank 60 is made of a copper alloy and includes a tin plating, but may be made of any desired material, may have any desired plating, or may have no plating. The stamped blank 60 is folded to create the female electrical terminal 28, and the features of the female electrical terminal 28 are identified on FIG. 3. However, the female electrical terminal 28 may be made by any other desired method. Although shown prior to assembly into the female electrical terminal 28 in FIG. 3, features of the female electrical terminal 28 are identified on the stamped blank 60.

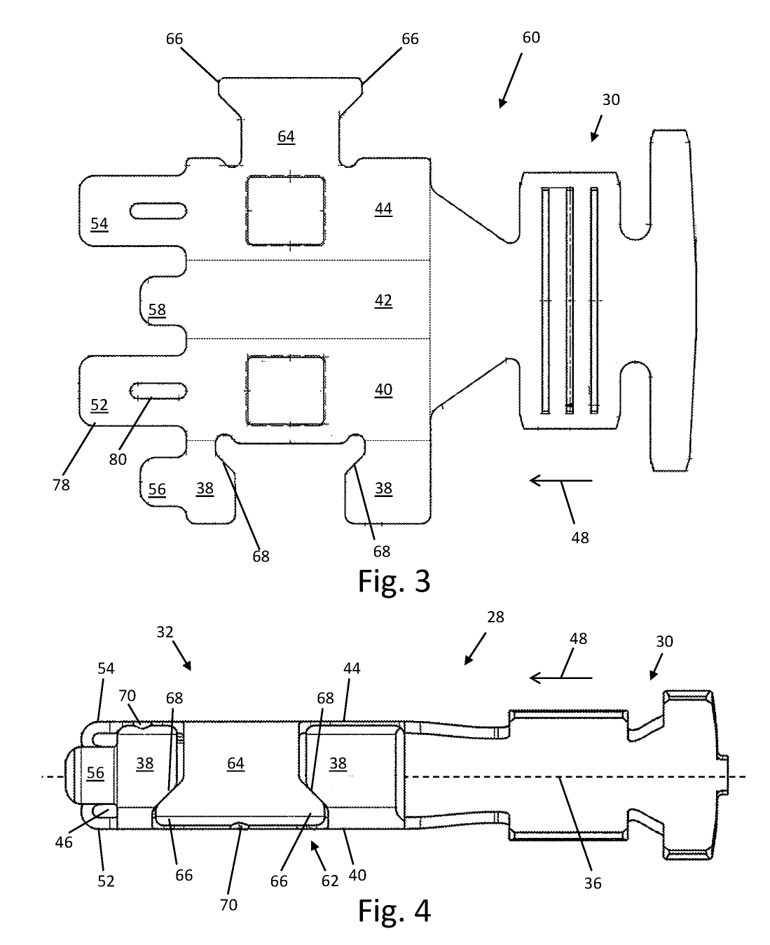

Referring now to FIG. 4, a plan view of the female electrical terminal 28 is shown after the stamped blank 60 of FIG. 3 is bent into its final shape. The female electrical terminal 28 includes a retaining structure, indicated generally at 62, that is adapted to maintain the shape of the box structure 34. The retaining structure 62 includes a tab 64 that extends from wall 44 of the box structure 34 and is folded so that the tab 64 is coplanar with the wall 38. The tab 64 includes two projections 66 that are positioned in respective indents 68 defined in the wall 38. The projections 66 engage the wall 38 to prevent the box structure 34 from coming apart during use of the female electrical terminal 28. The shape of the box structure 34 may be further retained by an optional weld 70 that is applied to the tab 64 and the wall 40, and an optional weld 70 that is applied to the wall 38 and the wall 44. One advantage of providing the projections 66 and the indents 68 is that terminal 28 resists coming apart when a male blade terminal is inserted into terminal 28, even in the absence of welds or in the case of weld failure.

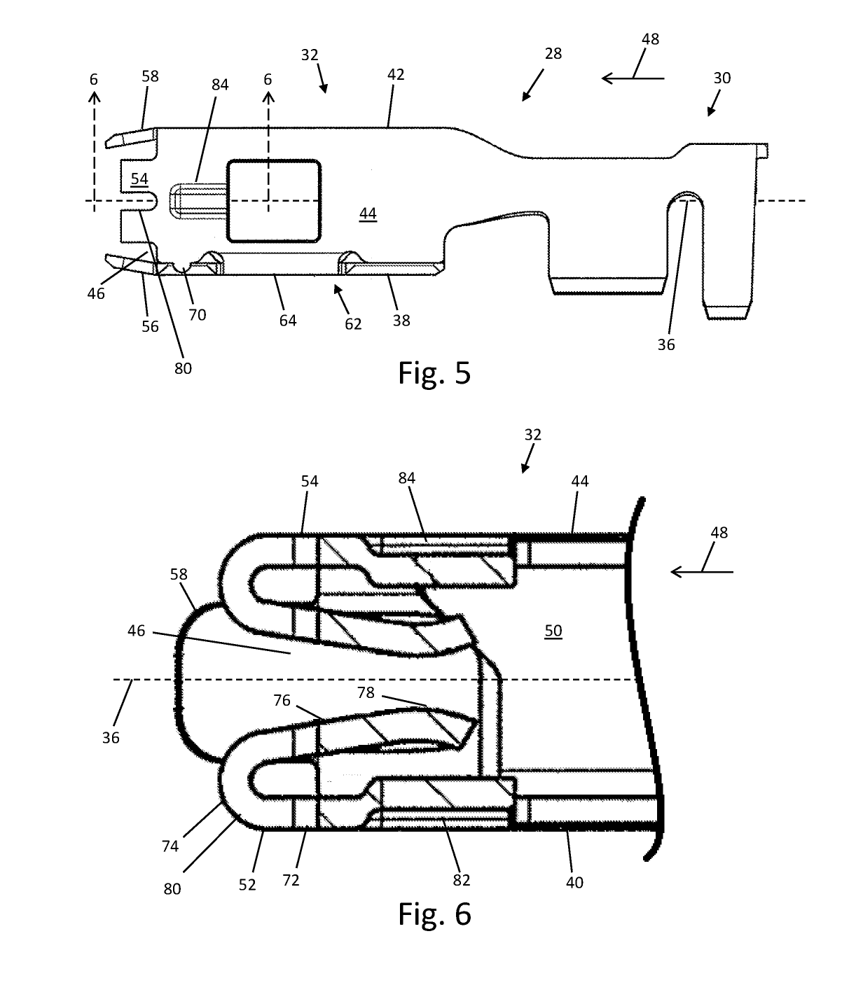

Referring now to FIG. 5, a side view of the female electrical terminal 28 is shown. As illustrated in FIG. 5, the wall 44 is viewed straight on, and the tab 64 is visible at the bottom of the figure. As shown, the guide 56 extends from the wall 38, and the guide 58 extends from the wall 42 (this can also be seen in the stamped blank 60 shown in FIG. 3). As shown, each guide 56 and 58 is an extension of the respective wall 38 and 42 that is angled toward the terminal axis 36. As also shown, the illustrated guides 56 and 58 extend farther in the insertion direction 48 than the contact arms 52 and 54. As a result, the guides 56 and 58 help protect the contact arms 52 and 54 from damage during, for example, insertion of the female electrical terminal 28 into a housing (not shown).

Referring now to FIG. 6, a cross-sectional view of a portion of the female electrical terminal 28 is shown, taken through the terminal axis 36 and along line 6-6 of FIG. 5. The cross-section illustrated in FIG. 6 is taken through the contact arms 52 and 54. The two contact arms 52 and 54 are mirror images of each other, having the same features. Thus, only the contact arm 52 will be described in detail. However, the contact arm 54 may have different features from the contact arm 52, if desired. As shown, the contact arm 52 includes an external portion 72 that extends from the wall 40 in the insertion direction 48 to a curved portion 74. The curved portion 74 of the contact arm 52 is bent inwardly toward the terminal axis 36 and in the direction opposite the insertion direction 48. The curved portion 74 extends from the external portion 72 to an internal portion 76 that is located closer to the terminal axis 36 than the external portion 72. The internal portion 76 includes a contact area 78, which is the portion of the contact arm 52 that will engage the corresponding male blade terminal. When the corresponding male blade terminal is inserted along the terminal axis 36, it will engage the contact area 78 and push it away from the terminal axis 36. The contact arm 52 will elastically deflected in the curved portion 74 and, thus, will provide a force to bias the contact area 78 toward the terminal axis 36.

The contact arm 52 also includes a notch 80. The illustrated notch 80 is a single cut-out area located in the curved portion 74. However, the notch 80 may be located in some other portion of the contact arm 52 if desired, and the contact arm 52 may include more than one notch 80. The illustrated notch 80 is located in the center of the contact arm 52, but may be located on any desired part of the contact arm 52. It should be appreciated that when the contact arm 52 is elastically deflected in the curved portion 74, the notch 80 reduces the amount of material that needs to be deflected. Therefore, the contact arm 52 is easier to deflect than it would be if the contact arm 52 did not include the notch 80. As a result, the notch 80 decreases the force needed to mate the corresponding male blade terminal with the female electrical terminal 28. It should be appreciated that the amount of force may be further reduced by making the notch 80 larger than illustrated or by providing additional notches 80 in the contact arm 52. That is, the width of notch 80 may be varied to adjust the amount of insertion force of a male blade terminal into female electrical terminal 28.

The female electrical terminal 28 includes two optional embossments 82 and 84 on the box structure 34. Each of the embossments 82 and 84 is located on one of the walls 40 and 44 adjacent to where the respective contact arm 52 and 54 extends from the wall 40 and 44. Each of the embossments 82 and 84 serves to stiffen the respective wall 40 and 44 in order to limit the bending of the contact arms 52 and 54 away from the terminal axis 36 when the female electrical terminal 26 is mated with the corresponding male terminal, and to prevent the shape of the box structure 34 from being deformed.

A method of assembling the female electrical terminal 28 according to a method of this invention can include the following steps: (1) stamping the blank 60 out of conductive metal; (2) bending the contact arms 52 and 54 over; (3) bending the guides 56 and 58; (4) bending the blank 60 about the axis 36 into a box shape with the projections 66 located adjacent to and in opposing relation to the indentations 68; and (5) providing the welds 70.

The principle and mode of operation of this invention have been explained and illustrated in its preferred embodiment. However, it must be understood that this invention may be practiced otherwise than as specifically explained and illustrated without departing from its spirit or scope.

1. A female electrical terminal comprising:
an attachment portion; and
a contact portion connected to the attachment portion, the contact portion including contact arms located on opposed sides of a terminal axis, the contact arms adapted to engage a corresponding male blade terminal inserted along the terminal axis, a notch located in one of the contact arms.

2. The female electrical terminal of claim 1, wherein the contact portion includes a box structure that is located around and extends along the terminal axis, wherein the contact arms extend from the box structure on opposed sides of the terminal axis.

3. The female electrical terminal of claim 2, further including guides that extend from the box structure on opposed sides of the terminal axis.

4. The female electrical terminal of claim 3, wherein the contact arms extend from the box structure in an insertion direction that is substantially parallel to the terminal axis, and the guides extend from the box structure farther in the insertion direction than the contact arms.

5. The female electrical terminal of claim 3, wherein the box structure defines an interior space, each contact arm extends from the box structure to a curved portion and from the curved portion into the interior space, and the notch is located in the curved portion of the contact arm.

6. A female electrical terminal comprising:
an attachment portion; and
a contact portion connected to the attachment portion, the contact portion including a box structure located around a terminal axis, contact arms that extend from the box structure on opposed sides of the terminal axis in an insertion direction that is substantially parallel to the terminal axis, and guides that extend from the box structure on opposed sides of the terminal axis farther in the insertion direction than the contact arms.

7. The female electrical terminal of claim 6, wherein the guides angle from the box structure toward the terminal axis.

8. The female electrical terminal of claim 6, wherein the box structure further includes at least one projection and at least one corresponding recess, said projection and said recess having mutually opposing surfaces that cooperate to prevent the box structure from coming apart about the terminal axis due to insertion of a male terminal into the female electrical terminal.

9. The female electrical terminal of claim 6, wherein the box structure further includes at least one projection and at least one corresponding recess, said projection and said recess having mutually opposing surfaces that cooperate to prevent the box structure from coming apart about the terminal axis due to force exerted between the contact arms.

10. A female electrical terminal comprising:
an attachment portion; and
a contact portion connected to the attachment portion, the contact portion including a box structure that is located around and extends along a terminal axis and contact arms extending from the box structure on opposed sides of the terminal axis and adapted to engage a corresponding male terminal inserted along the terminal axis;
wherein the box structure further comprises at least one projection and at least one corresponding recess, said projection and said recess having mutually opposing surfaces that cooperate to prevent the box structure from coming apart about the terminal axis due to insertion the corresponding male terminal into the female electrical terminal.
